(19) United States
(12) Patent Application Publication
(10) Pub. No.: US 2026/0205731 A1
(43) Pub. Date: Jul. 16, 2026

(54) VIBRATION TRANSMISSION PLATES, BONE CONDUCTION SOUNDING ASSEMBLIES, AND EARPHONES

(71) Applicant: SHENZHEN SHOKZ CO., LTD., Shenzhen (CN)

(72) Inventors: Shuai LIU, Shenzhen (CN); Junjiang FU, Shenzhen (CN)

(73) Assignee: SHENZHEN SHOKZ CO., LTD., Shenzhen (CN)

(21) Appl. No.: 19/434,059

(22) Filed: Dec. 29, 2025

Related U.S. Application Data
(63) Continuation of application No. PCT/CN2025/071908, filed on Jan. 10, 2025.

(51) Int. Cl. H04R 1/28; H04R 1/10

(52) U.S. Cl. CPC H04R 1/288; H04R 1/1008; H04R 1/1075; H04R 1/2873; H04R 2460/13

(57) ABSTRACT

The present disclosure relates to a vibration transmission plate, a bone conduction sounding assembly, and an earphone. The vibration transmission plate includes an inner ring portion, an outer ring portion, and a plurality of connecting rods connected between the inner ring portion and the outer ring portion. The connecting rod includes a rod body, a first connection portion, and a second connection portion. The vibration transmission plate includes a major axis and a minor axis, a size of the vibration transmission plate along the major axis being greater than a size along the minor axis, and also includes a first reference point located at a connection between the first connection portion and the rod body, a second reference point located at a connection between the second connection portion and the rod body, and a first reference line defined by the first reference point and the second reference point.

### CROSS-REFERENCE TO RELATED APPLICATIONS

This application is a continuation of International Application No. PCT/CN 2025/071908 filed on Jan. 10, 2025, the entire contents of which are incorporated herein by reference.

### TECHNICAL FIELD

The present disclosure relates to the field of acoustic technology, and in particular, to a vibration transmission plate, a bone conduction sounding assembly, and an earphone.

### BACKGROUND

With the continuous popularization of electronic devices, electronic devices have become indispensable social and entertainment tools in the daily lives of people. People have increasingly higher requirements for electronic devices. Electronic devices such as earphones have been widely used in the daily lives of people. The earphones can be used in conjunction with terminal devices such as mobile phones and computers to provide users with an auditory feast.

A bone conduction sounding assembly is capable of converting sound into mechanical vibrations of different frequencies and transmitting sound waves through the skull, bony labyrinth, endolymph, spiral organ, and auditory center of a person. A vibration transmission plate is usually provided in the bone conduction sounding assembly. The vibration transmission plate may support a transducer device for vibration in the bone conduction sounding assembly. However, the vibration transmission plate also vibrates in the air while supporting the vibration of the transducer device, thereby generating air conduction noise and affecting the sound output effect of the bone conduction sounding assembly.

### SUMMARY

The present disclosure provides a vibration transmission plate, a bone conduction sounding assembly, and an earphone, which can reduce air conduction noise generated by the vibration transmission plate and improve a sound output effect of the bone conduction sounding assembly.

In a first aspect, one technical solution adopted by the present disclosure is to provide a vibration transmission plate. The vibration transmission plate includes: an inner ring portion; an outer ring portion; and a plurality of connecting rods connected between the inner ring portion and the outer ring portion, the connecting rod including a rod body, a first connection portion, and a second connection portion, one end of the rod body is connected to the inner ring portion via the first connection portion, the first connection portion is arranged in a gradually widening manner along a direction approaching the inner ring portion; the other end of the rod body is connected to the outer ring portion via the second connection portion, the second connection portion is arranged in a gradually widening manner along a direction approaching the outer ring portion; when viewed along an axial direction of the vibration transmission plate, the vibration transmission plate includes a major axis and a minor axis intersecting each other, a size of the vibration transmission plate along the major axis is greater than a size along the minor axis; and the vibration transmission plate further includes a first reference point located at a connection between the first connection portion and the rod body, a second reference point located at a connection between the second connection portion and the rod body, and a first reference line defined by the first reference point and the second reference point, the rod body is divided by the first reference line into a first portion and a second portion located on two sides of the first reference line, and an area ratio of the first portion to the second portion is between 0.8 and 1.2.

In some embodiments, the area ratio of the first portion to the second portion is between 0.9 and 1.1.

In some embodiments, the rod body includes a first main edge and a second main edge arranged opposite to each other; the first connection portion includes a first transition edge connecting the first main edge and an outer ring edge of the inner ring portion, the second connection portion includes a second transition edge connecting the second main edge and an inner ring edge of the outer ring portion, and the first transition edge and the second transition edge are respectively configured as a concave arc; and the first reference point is a connection point between the first transition edge and the first main edge, the second reference point is a connection point between the second transition edge and the second main edge, and remaining intersection points of the first reference line with the first main edge and the second main edge are located between the first reference point and the second reference point.

In some embodiments, the rod body includes a plurality of straight rod sections arranged side by side and spaced apart from each other and a plurality of curved rod sections sequentially connecting the plurality of straight rod sections; the vibration transmission plate further includes a second reference line passing through a midpoint of a line connecting the first reference point and the second reference point and intersecting the first reference line, the second reference line is located between two adjacent straight rod sections of the plurality of straight rod sections and is parallel to the two adjacent straight rod sections; and the rod body is divided by the second reference line into a third portion and a fourth portion located on two sides of the second reference line, an area ratio of the third portion to the fourth portion is between 0.8 and 1.2.

In some embodiments, the rod body includes a first main edge and a second main edge arranged opposite to each other, the first main edge includes a first straight edge located on the straight rod section and a first curved edge located on the curved rod section; and the second main edge includes a second straight edge located on the straight rod section and a second curved edge located on the curved rod section, the first straight edge and the second straight edge located a same straight rod section are parallel to each other; the first straight edge is tangent to the first curved edge connected thereto; the second straight edge is tangent to the second curved edge connected thereto; and the first curved edge and the second curved edge located a same curved rod section are configured in a concentric arc shape.

In some embodiments, the area ratio of the third portion to the fourth portion is between 0.9 and 1.1.

In some embodiments, counts of the curved rod sections on two sides of the first reference line are the same.

In some embodiments, an intersection angle between the second reference line and the first reference line is between 80° and 100°.

In some embodiments, the vibration transmission plate further includes a backing film attached to the inner ring portion, the outer ring portion, and the plurality of connecting rods.

In some embodiments, counts of the curved rod sections on two sides of the first reference line are respectively between 3 and 8.

In some embodiments, lengths of the plurality of straight rod sections increase along a direction approaching the second reference line.

In some embodiments, the inner ring portion and/or the outer ring portion is provided with a wiring hole; the vibration transmission plate further includes a third reference line and a fourth reference line, the third reference line and the fourth reference line passing through a center of the inner ring portion and respectively intersecting the outer ring portion, thereby defining a wiring area; and the wiring hole is located in the wiring area, the connecting rod is located outside the wiring area, and an angle between the third reference line and the fourth reference line for defining the wiring area is between 30° and 50°.

In a second aspect, one technical solution adopted by the present disclosure is to provide a bone conduction sounding assembly. The bone conduction sounding assembly: a housing; a transducer device; and the vibration transmission plate according to the above embodiments. The vibration transmission plate is configured to connect the transducer device and the housing, and suspendably mount the transducer device to the housing.

In a second aspect, one technical solution adopted by the present disclosure is to provide an earphone. The earphone includes the bone conduction sounding assembly according to the above embodiments.

The beneficial effects of the present disclosure are as follows. Different from the prior art, the vibration transmission plate of the present disclosure is provided with the inner ring portion, the outer ring portion, and the plurality of connecting rods connected between the inner ring portion and the outer ring portion. One end of the connecting rod is connected to the inner ring portion, and the other end of the connecting rod is connected to the outer ring portion via the second connection portion, a connection point between the connecting rod and the inner ring portion and a connection point between the connecting rod and the outer ring portion define the first reference line, the rod body of the connecting rod is divided into the first portion and the second portion by the first reference line. The area ratio of the first portion to the second portion is between 0.8 and 1.2. With such a configuration, areas of the first portion and the second portion can be made consistent or close to consistent. When the first portion and the second portion with similar areas generate deformations in opposite directions in an Nth mode of the vibration transmission plate, air conduction noises generated by the first portion and the second portion can cancel each other out, thereby achieving an effect of weakening air conduction noise of the rod body, so as to improve the sound output effect of the bone conduction sounding assembly and enhance sound quality of the earphone.

### BRIEF DESCRIPTION OF THE DRAWINGS

FIG. 1 is a schematic diagram illustrating a three-dimensional structure of an earphone according to some embodiments of the present disclosure;

FIG. 2 is a schematic diagram illustrating an exploded structure of the earphone shown in FIG. 1;

FIG. 3 is a schematic diagram illustrating a three-dimensional structure of a bone conduction sounding assembly in the earphone shown in FIG. 2;

FIG. 4 is a schematic diagram illustrating a cross-sectional structure of the bone conduction sounding assembly shown in FIG. 3 taken along a section line A-A;

FIG. 5 is a schematic diagram illustrating an exploded structure of the bone conduction sounding assembly shown in FIG. 3;

FIG. 6 is a schematic diagram illustrating an overall structure of a vibration transmission plate in the bone conduction sounding assembly shown in FIG. 5;

FIG. 7 is a full-scale enlarged structural diagram of region O in the vibration transmission plate shown in FIG. 6;

FIG. 8 is a schematic diagram illustrating a side structure of the vibration transmission plate in the earphone in an N-th mode;

FIG. 9 is a schematic diagram illustrating a part of another side structure of the vibration transmission plate in the earphone in the N-th mode;

FIG. 10 is a schematic diagram illustrating a side structure of the vibration transmission plate in the earphone in an (N+1)-th mode;

FIG. 11 is a schematic diagram illustrating a part of another side structure of the vibration transmission plate in the earphone in the (N+1)-th mode;

FIG. 12 is a schematic diagram illustrating another exploded structure of the bone conduction sounding assembly shown in FIG. 3;

FIG. 13 is a schematic diagram illustrating a further exploded structure of the bone conduction sounding assembly shown in FIG. 3;

FIG. 14 is a schematic diagram illustrating a side structure of the vibration transmission plate in the earphone in an (N+2)-th mode; and

FIG. 15 is a schematic diagram illustrating a part of another side structure of the vibration transmission plate in the earphone in the (N+2)-th mode.

### DETAILED DESCRIPTION

The following describes the present disclosure in further detail with reference to the accompanying drawings and embodiments. It is specifically pointed out that the following embodiments are merely for illustrating the present disclosure, but do not limit the scope of the present disclosure. Similarly, the following embodiments are only some embodiments of the present disclosure rather than all embodiments. All other embodiments obtained by a person of ordinary skill in the art based on the embodiments of the present disclosure without creative efforts, shall fall within the protection scope of the present disclosure.

Reference to “an embodiment” in the present disclosure means that a particular feature, structure, or characteristic described in connection with the embodiment can be included in at least one embodiment of the present disclosure. A person skilled in the art explicitly and implicitly understands that the embodiments described in the present disclosure can be combined with other embodiments.

The following descriptions are exemplary descriptions of an earphone in an earphone embodiment.

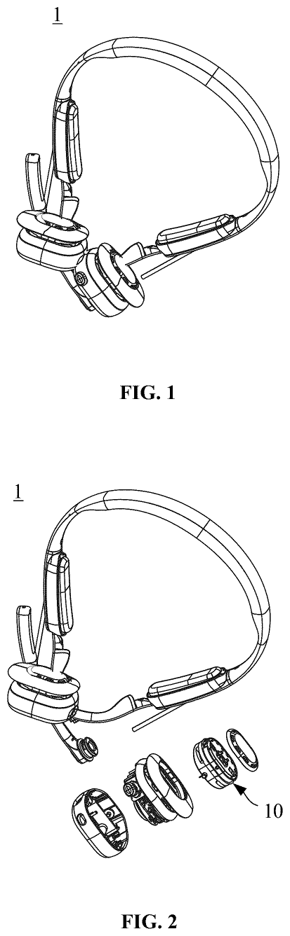

As shown in FIG. 1, an earphone 1 refers to an audio transducer capable of receiving an electrical signal from a media player or a receiver, converting the electrical signal into a bone conduction sound, and transmitting the bone conduction sound to a user. In other embodiments, the earphone 1 may also synchronously convert the electrical signal into an air conduction sound (a sound wave that can be heard by the user), and may also transmit the air conduction sound to the user. In some embodiments, the earphone 1 may be an open earphone, such as an ear-hook earphone, a behind-the-neck earphone, or an ear-clip earphone.

As shown in FIG. 2, the earphone 1 may include a bone conduction sounding assembly 10. The bone conduction sounding assembly 10 may be configured to be placed in a facial area in front of the tragus of a left ear and/or a right ear of the user, and fit the facial area of the user. The bone conduction sounding assembly 10 is configured to convert an electrical signal containing related audio information into a bone conduction sound and further transmit the bone conduction sound to the user.

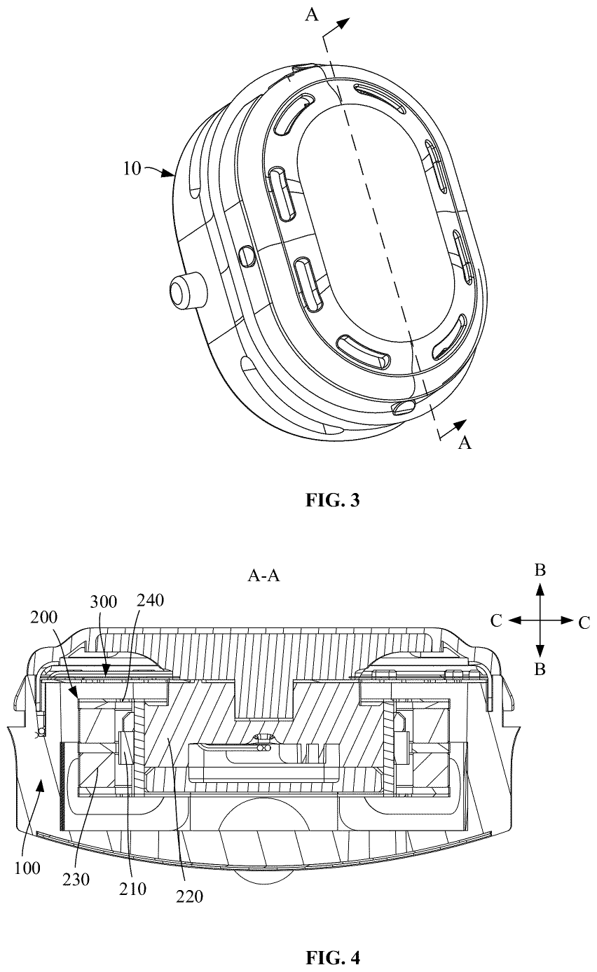

In some embodiments, as shown in FIG. 3 to FIG. 5, the bone conduction sounding assembly 10 may include a housing 100, a transducer device 200, and a vibration transmission plate 300. The vibration transmission plate 300 may be configured to connect the transducer device 200 and the housing 100, and suspendably mount the transducer device 200 to the housing 100.

The transducer device 200 is a main device in the bone conduction sounding assembly 10 for converting the electrical signal into the bone conduction sound.

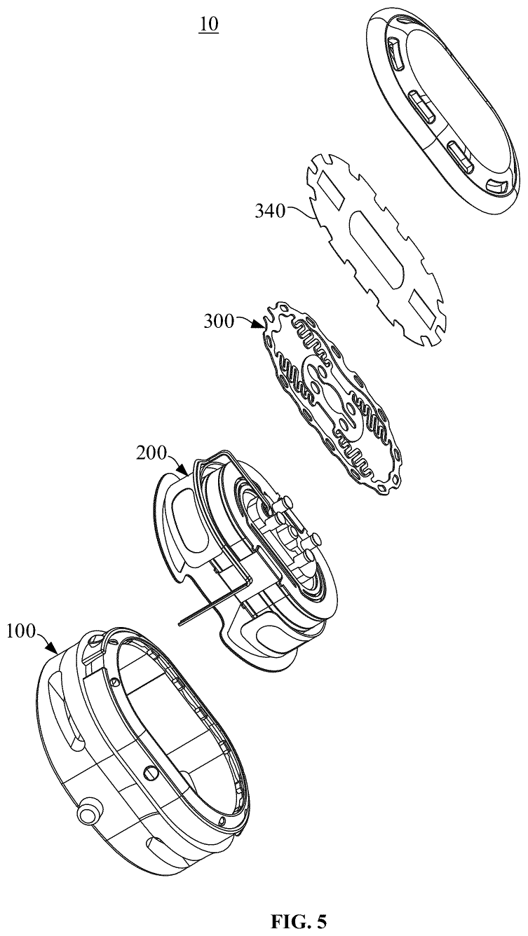

In some embodiments, as shown in FIG. 4, the transducer device 200 may include a voice coil 210, a bracket 220, a magnetic circuit system 230, and a connection vibration transmission plate 240. The connection vibration transmission plate 240 connects the bracket 220 and the magnetic circuit system 230 to elastically suspend the magnetic circuit system 230 around the bracket 220. The voice coil 210 is disposed on the bracket 220 and cooperates with the magnetic circuit system 230. In some embodiments, when the voice coil 210 is connected to the electrical signal containing related audio information, the magnetic circuit system 230 may drive the voice coil 210 and the bracket 220 to vibrate together.

The voice coil 210 may be connected to an electrical signal containing related audio information. The bracket 220 may be disposed inside the magnetic circuit system 230. The voice coil 210 may be wound and fixed on the bracket 220 along a radial direction of the bracket 220. The voice coil 210 is opposite to the magnetic circuit system 230, so that when the voice coil 210 is connected to the electrical signal containing related audio information, an electric field of the voice coil 210 can interact with a magnetic field of the magnetic circuit system 230. It is understood that the radial direction of the bracket 220 may be perpendicular to a vibration direction of the bracket 220. The vibration direction of the bracket 220 is an axial direction of the transducer device 200. Merely by way of example, the axial direction of the transducer device 200 may be shown by an arrow B in FIG. 4, and the radial direction of the bracket 220 may be shown by an arrow C in FIG. 4.

In some embodiments, since the voice coil 210 is opposite to the magnetic circuit system 230 in a radial direction C of the transducer device 200, the electric field of the voice coil 210 may interact with the magnetic field of the magnetic circuit system 230, so that an electromagnetic reaction occurs, so as to cause the magnetic circuit system 230 and the bracket 220 on which the voice coil 210 is disposed to move relative to each other, so that the transducer device 200 vibrates and generates the bone conduction sound capable of transmitting related audio information.

The connection vibration transmission plate 240 may undergo a certain elastic deformation under an external force and may restore to an original shape after the external force is removed. Since the connection vibration transmission plate 240 connects the bracket 220 and the magnetic circuit system 230, when the magnetic circuit system 230 and the voice coil 210 move relative to each other, the magnetic circuit system 230 and the bracket 220 on which the voice coil 210 is disposed move relative to each other. At the same time, the connection vibration transmission plate 240 may elastically constrain the magnetic circuit system 230 and the bracket 220 on which the voice coil 210 is disposed, so as to limit the bracket 220 in the magnetic circuit system 230, so that the operation of the transducer device 200 remains stable.

The vibration transmission plate 300 may be connected to the bracket 220 of the transducer device 200 to be fixed to the transducer device 200. The vibration transmission plate 300 may also be connected to the housing 100 to suspend the transducer device 200 in a space inside the housing 100. When the transducer device 200 vibrates, the vibration transmission plate 300 may be driven to undergo elastic deformation. The transducer device 200 may thus transmit the bone conduction sound to the user. The vibration transmission plate 300 may further constrain the transducer device 200 and may also play a vibration-damping role for the transducer device 200, so that the transducer device 200 is located inside the housing 100 without being separated from the housing 100, thereby enabling a structure of the earphone 1 can be more reliable and stable.

In some embodiments, the vibration transmission plate 300 may be made of a metal material. The metal material may include, but is not limited to, a steel (e.g., a stainless steel, a carbon steel, etc.), a light alloy (e.g., an aluminum alloy, beryllium copper, a magnesium alloy, a titanium alloy, etc.), etc. In some embodiments, the vibration transmission plate 300 may also be made of other single materials or composite materials that can achieve the same performance. For example, the composite material may include, but is not limited to, a reinforcing material such as glass fiber, carbon fiber, boron fiber, graphite fiber, silicon carbide fiber, aramid fiber, etc.

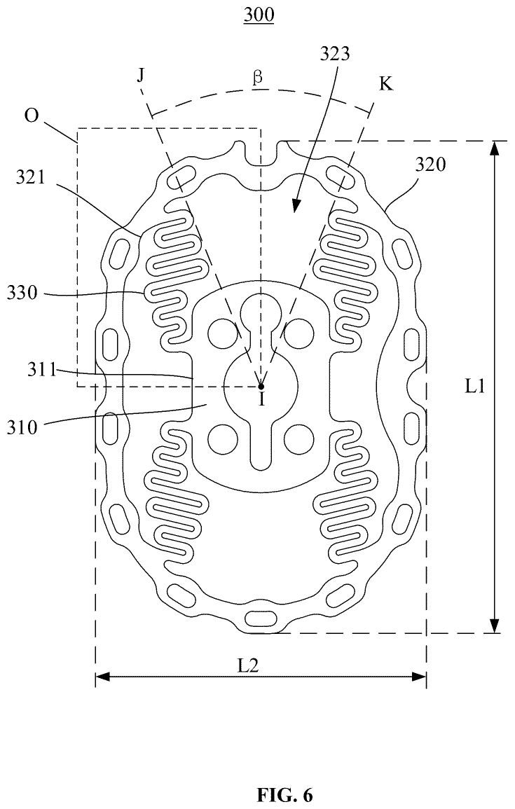

In some embodiments, as shown in FIG. 6 and FIG. 7, the vibration transmission plate 300 may include an inner ring portion 310, an outer ring portion 320, and a plurality of connecting rods 330 connected between the inner ring portion 310 and the outer ring portion 320. The inner ring portion 310 may be connected to the transducer device 200. The outer ring portion 320 may be connected to the housing 100. The plurality of connecting rods 330 connect the inner ring portion 310 and the outer ring portion 320, thereby suspending the transducer device 200 inside the housing 100. Therefore, when the transducer device 200 vibrates relative to the housing 100, the plurality of connecting rods 330 undergo large deformation.

The connecting rod 330 may include a rod body 331, a first connection portion 332, and a second connection portion 333. One end of the rod body 331 is connected to the inner ring portion 310 via the first connection portion 332. The first connection portion 332 is arranged in a gradually widening manner along a direction approaching the inner ring portion 310. The other end of the rod body 331 is connected to the outer ring portion 320 via the second connection portion 333. The second connection portion 333 is arranged in a gradually widening manner along a direction approaching the outer ring portion 320.

Setting the first connection portion 332 to be arranged in the gradually widening manner in the direction approaching the inner ring portion 310 and setting the second connection portion 333 to be arranged in the gradually widening manner in the direction approaching the outer ring portion 320 can improve a connection strength between the connecting rod 330 and the inner ring portion 310 and the outer ring portion 320, so that when the connecting rod 330 deforms, a phenomenon of a fracture of the first connection portion 332 and the second connection portion 333 is reduced, thereby improving a structural strength of the vibration transmission plate 300.

When viewed along an axial direction B of the vibration transmission plate 300, the vibration transmission plate 300 includes a major axis and a minor axis intersecting each other. A size of the vibration transmission plate 300 along the major axis is greater than a size of the vibration transmission plate 300 along the minor axis. Merely by way of example, the size of the vibration transmission plate 300 along the major axis may be shown by a length L1 in FIG. 6, and the size of the vibration transmission plate 300 along the minor axis may be shown by a length L2 in FIG. 6. When viewed along the axial direction B of the transducer device 200, the vibration transmission plate 300 includes an overall track shape or an elliptical shape.

The vibration transmission plate 300 further includes a first reference point located at a connection between the first connection portion 332 and the rod body 331, a second reference point located at a connection between the second connection portion 333 and the rod body 331, and a first reference line defined by the first reference point and the second reference point. Merely by way of example, the first reference point may be shown by a point D in FIG. 7, the second reference point may be shown by a point E in FIG. 7, and the first reference line may be shown by a line segment ED in FIG. 7.

The rod body 331 is divided by the first reference line ED into a first portion 3311 and a second portion 3312 located on two sides of the first reference line ED, and an area ratio of the first portion 3311 to the second portion 3312 may be between 0.8 and 1.2. Merely by way of example, the area ratio of a first portion 3311 to a second portion 3312 may be values such as 0.8, 0.85, 0.88, 0.92, 0.95, 0.97, 1, and 1.2.

Since the transducer device 200 drives the vibration transmission plate 300 to move during vibration, the connecting rod 330 in the vibration transmission plate 300 deforms. When the connecting rod 330 deforms and moves in the air with the transducer device 200, an air conduction noise is generated, thereby affecting a sound output effect of the bone conduction sounding assembly 10 and reducing sound quality of the earphone 1. The air conduction noise refers to a sound generated when the connecting rod 330 vibrates with the transducer device 200 during vibration of the transducer device 200, causing the connecting rod 330 to undergo non-ideal swing (may be transmission or damping under an ideal condition). The air conduction noise is different from vibration of the bone conduction sound of the transducer device 200 and belongs to the air conduction sound. A generated air conduction noise is transmitted from an opening of the housing 100, interfering with sound generation of the bone conduction sounding assembly 10, thereby affecting the sound output effect of the earphone 1.

The earphone 1 vibrates and produces sound in an audible frequency band of a human ear, for example, the audible frequency may be between 500 Hz and 12000 Hz. The vibration sound generation of the bone conduction sounding assembly 10 may cause a vibration deformation of the vibration transmission plate 300. In the exemplary frequency band, some specific frequency bands may exist to cause the vibration transmission plate 300 to undergo severe deformation, generate a non-ideal noise, and may also cause structural failure of the bone conduction sounding assembly 10. In research, the inventor of the present disclosure has found that vibration modes of the vibration transmission plate 300 in at least three specific frequency bands may have the above problems. The following uses an Nth mode, an (N+1)th mode, and an (N+2)th mode for analysis and explanation of the significance of structural improvement.

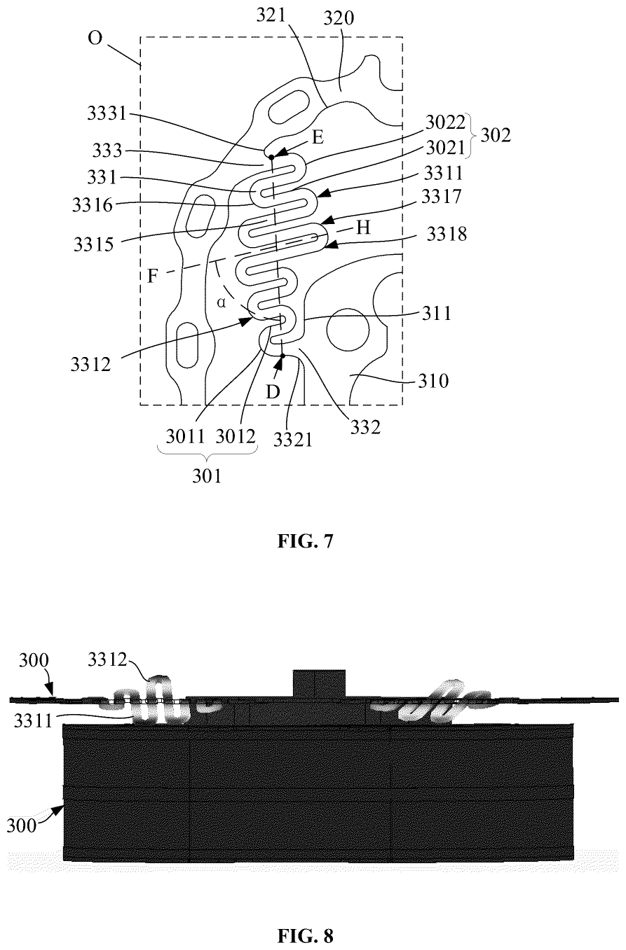

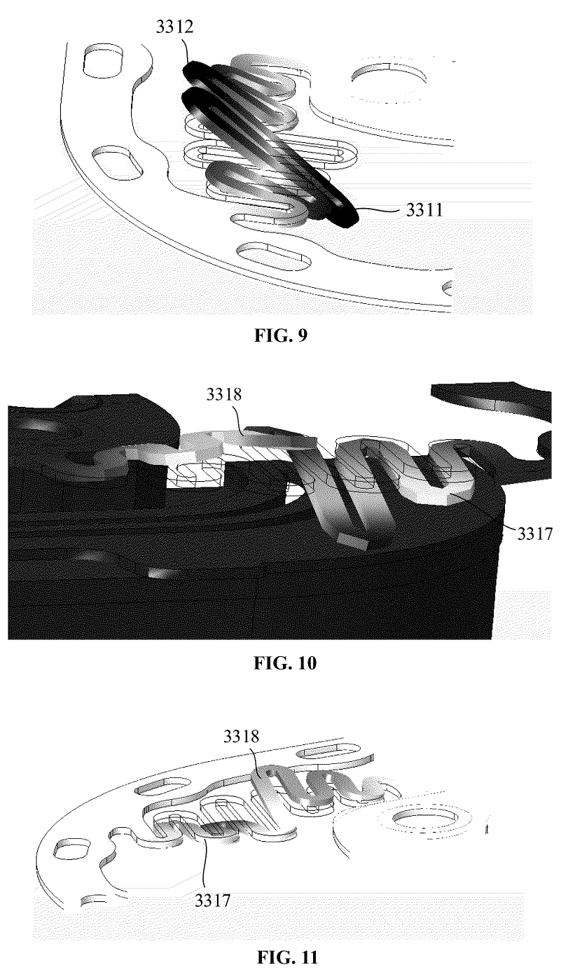

During deformation of the rod body 331, the Nth mode exists. In the Nth mode, the first portion 3311 and the second portion 3312 of the rod body 331 move relative to each other in opposite directions. For example, the Nth mode of the rod body 331 may present a mode shown in FIG. 8 and FIG. 9 or a mode similar to that shown in FIG. 8 and FIG. 9. For example, the first portion 3311 moves to one side along the axial direction B of the transducer device 200, and the second portion 3312 moves to the other side along the axial direction B of the transducer device 200.

Therefore, the area ratio of the first portion 3311 to the second portion 3312 is set between 0.8 and 1.2, so that areas of the first portion 3311 and the second portion 3312 are equal or substantially equal. Thus, when the first portion 3311 and the second portion 3312 with similar masses and volumes deform in opposite directions in the Nth mode, air conduction noises generated by the first portion 3311 and the second portion 3312 may cancel each other out, thereby achieving an effect of reducing the air conduction noise of the rod body 331, so as to improve the sound output effect of the bone conduction sounding assembly 10 and enhance the sound quality of the earphone 1. Furthermore, using the first reference line ED to distinguish the first portion 3311 and the second portion 3312 allows a distinction between the first portion 3311 and the second portion 3312 to be combined with a shape of the vibration transmission plate 300, thereby making a distribution of the first portion 3311 and the second portion 3312 more reasonable.

If the area ratio of the first portion 3311 to the second portion 3312 is less than 0.8 or greater than 1.2, it indicates that the areas of the first portion 3311 and the second portion 3312 differ too greatly. Then, in the Nth mode of the rod body 331, when the first portion 3311 and the second portion 3312 move in opposite directions, the air conduction noises generated by the first portion 3311 and the second portion 3312 are difficult to cancel each other out. Therefore, the rod body 331 in the Nth mode still has a significant noise in the Nth mode.

In some embodiments, the area ratio of the first portion 3311 to the second portion 3312 is between 0.9 and 1.1. For example, the area ratio of the first portion 3311 to the second portion 3312 may be values such as 0.9, 0.91, 0.96, 0.98, 1, or 1.1.

Setting the area ratio of the first portion 3311 to the second portion 3312 between 0.9 and 1.1 allows the areas of the first portion 3311 and the second portion 3312 to be equal or substantially equal. Thus, a majority of the air conduction noises generated by the first portion 3311 and the second portion 3312 in the Nth mode may cancel each other out, which is more conducive to reducing the air conduction noise generated by the rod body 331, thereby further improving the sound output effect of the bone conduction sounding assembly 10 and enhancing the sound quality of the earphone 1.

In some embodiments, as shown in FIG. 7, the rod body 331 includes a first main edge 301 and a second main edge 302 arranged opposite to each other. The first connection portion 332 includes a first transition edge 3321 connecting the first main edge 301 and an outer ring edge 311 of the inner ring portion 310. The second connection portion 333 includes a second transition edge 3331 connecting the second main edge 302 and an inner ring edge 321 of the outer ring portion 320, and the first transition edge 3321 and the second transition edge 3331 are respectively configured as a concave arc.

As used herein, “configured as the concave arc” refers to that both the first transition edge 3321 and the second transition edge 3331 are recessed toward a solid portion. Furthermore, concave arc shapes of the first transition edge 3321 and the second transition edge 3331 include, but are not limited to, an arc shape, and may also be a curved travel shape with a continuously varying radius of curvature.

The first reference point D is a connection point between the first transition edge 3321 and the first main edge 301, the second reference point E is a connection point between the second transition edge 3331 and the second main edge 302, and remaining intersection points of the first reference line ED with the first main edge 301 and the second main edge 302 are located between the first reference point D and the second reference point E. Thus, using starting points of the first connection portion 332 and the second connection portion 333 in a gradually widening manner as the first reference point D and the second reference point E, and setting the remaining intersection points of the first reference line ED with the first main edge 301 and the second main edge 302 located between the first reference point D and the second reference point E, are more conducive to a cancellation of the air conduction noises between the first portion 3311 and the second portion 3312, thereby further reducing the air conduction noise of the rod body 331.

In some embodiments, as shown in FIG. 7, the rod body 331 may include a plurality of straight rod sections 3315 arranged side by side and spaced apart from each other, and a plurality of curved rod sections 3316 sequentially connecting the plurality of straight rod sections 3315. The vibration transmission plate 300 further includes a second reference line passing through a midpoint of a line connecting the first reference point D and the second reference point E and intersecting the first reference line ED. The second reference line is located between two adjacent straight rod sections 3315 of the plurality of straight rod sections and is parallel to the two adjacent straight rod sections 3315. The second reference line may be represented by a line segment FH shown in FIG. 7.

As shown in FIG. 7, the rod body 331 is divided by the second reference line FH into a third portion 3317 and a fourth portion 3318 located on two sides of the second reference line FH. An area ratio of the third portion 3317 to the fourth portion 3318 is between 0.8 and 1.2. For example, the area ratio between the third portion 3317 and the fourth portion 3318 may be values such as 0.8, 0.83, 0.85, 0.88, 0.92, 0.95, 0.97, 1, or 1.2.

Since the (N+1)th mode exists during the deformation of the rod body 331, in the (N+1)th mode, the third portion 3317 and the fourth portion 3318 of the rod body 331 move relative to each other in opposite directions, thereby generating significant air conduction noise. For example, the (N+1)th mode of the rod body 331 may present a mode shown in FIG. 10 and FIG. 11 or a mode similar to that shown in FIG. 10 and FIG. 11. For example, the third portion 3317 moves to one side along the axial direction B of the transducer device 200, and the fourth portion 3318 moves to the other side along the axial direction B of the transducer device 200.

Setting the area ratio of the third portion 3317 to the fourth portion 3318 between 0.8 and 1.2 allows areas of the third portion 3317 and the fourth portion 3318 to be equal or substantially equal. When the third portion 3317 and the fourth portion 3318 with similar areas deform in the opposite directions in the (N+1)th mode, the air conduction noises generated by the third portion 3317 and the fourth portion 3318 may cancel each other out, thereby achieving the effect of reducing the air conduction noise of the rod body 331, so as to improve the sound output effect of the bone conduction sounding assembly 10 and enhance the sound quality of the earphone 1.

In some embodiments, the area ratio of the third portion 3317 to the fourth portion 3318 is between 0.9 and 1.1. For example, the area ratio of the third portion 3317 to the fourth portion 3318 may be values such as 0.9, 0.91, 0.96, 0.98, 1, or 1.1.

Setting the area ratio of the third portion 3317 to the fourth portion 3318 between 0.9 and 1.1 allows areas of the third portion 3317 and the fourth portion 3318 to be equal or substantially equal. Thus, a majority of the air conduction noises generated by the third portion 3317 and the fourth portion 3318 in the (N+1)th mode may cancel each other out, which is more conducive to reducing the air conduction noise generated by the rod body 331, thereby further improving the sound output effect of the bone conduction sounding assembly 10 and enhancing the sound quality of the earphone 1.

In some embodiments, as shown in FIG. 7, the rod body 331 includes the first main edge 301 and the second main edge 302 arranged opposite to each other. The first main edge 301 includes a first straight edge 3011 located on the straight rod section 3315 and a first curved edge 3012 located on the curved rod section 3316. The second main edge 302 includes a second straight edge 3021 located on the straight rod section 3315 and a second curved edge 3022 located on the curved rod section 3316.

The first straight edge 3011 and the second straight edge 3021 located on a same straight rod section 3315 are parallel to each other. The first straight edge 3011 is tangent to the first curved edge 3012 connected thereto. The second straight edge 3021 is tangent to the second curved edge 3022 connected thereto. The first curved edge 3012 and the second curved edge 3022 located on a same curved rod section 3316 are configured as a concentric arc shape.

With this configuration, a width of the curved rod section 3316 is equal to or slightly greater than a width of the straight rod section 3315. Furthermore, configuring the first curved edge 3012 and the second curved edge 3022 corresponding to the same curved rod section 3316 as the concentric arc shape may enable the rod body 331 to have a greater structural strength and a more balanced structural strength at various portions, thereby reducing a fracture probability at any position when the rod body 331 deforms.

In some embodiments, counts of the plurality of curved rod sections 3316 on two sides of the first reference line ED are the same. This configuration improves a structural consistency and balance between the first portion 3311 and the second portion 3312 on the two sides of the first reference line ED, and reduces a difference between the first portion 3311 and the second portion 3312. This is more conducive to the mutual cancellation of the air conduction noises between the first portion 3311 and the second portion 3312, thereby improving the sound output effect of the bone conduction sounding assembly 10.

In some embodiments, as shown in FIG. 7, an intersection angle between the second reference line FH and the first reference line ED is between 80° and 100°. For example, the intersection angle between the second reference line FH and the first reference line ED may be represented by an angle α shown in FIG. 7. For example, the intersection angle between the second reference line FH and the first reference line ED may be values such as 80°, 85°, 90°, 95°, or 100°.

Since the first reference line ED is determined based on connection reference points between the connecting rod 330 and the inner ring portion 310 and the outer ring portion 320, and the second reference line FH is parallel to the two adjacent straight rod sections 3315 of the plurality of straight rod sections 3315, the straight rod sections 3315 intersect the first reference line ED. Furthermore, the vibration transmission plate 300 has an overall racetrack shape or an elliptical shape. Therefore, if the intersection angle between the second reference line FH and the first reference line ED is less than 80° or greater than 100°, the plurality of straight rod section 3315 and the plurality of curved rod sections 3316 of the connecting rod 330 would be closer to the outer ring edge 311 of the inner ring portion 310 and the inner ring edge 321 of the outer ring portion 320, which would cause the connecting rod 330 to easily touch and interfere with the inner ring portion 310 and the outer ring portion 320 during vibration, thereby causing the connecting rod 330 to generate more noises and be more prone to fracture and damage.

Therefore, setting the intersection angle between the second reference line FH and the first reference line ED between 80° and 100° enables the second reference line FH and the first reference line ED to be perpendicular or substantially perpendicular to each other, and the plurality of straight rod sections 3315 are also perpendicular or substantially perpendicular to the first reference line ED. This causes the plurality of straight rod sections 3315 and the plurality of curved rod sections 3316 of the connecting rod 330 to be away from the outer ring edge 311 of the inner ring portion 310 and the inner ring edge 321 of the outer ring portion 320, thereby reducing instances where the connecting rod 330 touches and interferes with the inner ring portion 310 and the outer ring portion 320, and consequently reducing noise generated by the connecting rod 330 and reducing instances where the connecting rod 330 fractures due to deformation and collision with the inner ring portion 310 or the outer ring portion 320.

In some embodiments, as shown in FIG. 7, lengths of the plurality of straight rod sections 3315 may be set to increase in a direction toward the second reference line FH. In other words, a length direction of the straight rod section 3315 may be parallel to a direction of the second reference line FH.

Since the second reference line FH and the first reference line ED are perpendicular or substantially perpendicular to each other, the straight rod section 3315 is also perpendicular or substantially perpendicular to the first reference line ED. Furthermore, two ends of the first reference line ED are the inner ring portion 310 and the outer ring portion 320, and the curved rod sections 3316 are located at the two ends of the straight rod sections 3315. Therefore, setting the lengths of the plurality of straight rod sections 3315 to increase in the direction toward the second reference line FH causes the straight rod sections 3315 and the curved rod sections 3316 to be away from the outer ring edge 311 of the inner ring portion 310 and the inner ring edge 321 of the outer ring portion 320, which reduces instances where the rod body 331 touches and interferes with the inner ring portion 310 and the outer ring portion 320, thereby reducing noise generated by the connecting rod 330 and reducing instances where the connecting rod 330 fractures due to deformation and collision with the inner ring portion 310 or the outer ring portion 320.

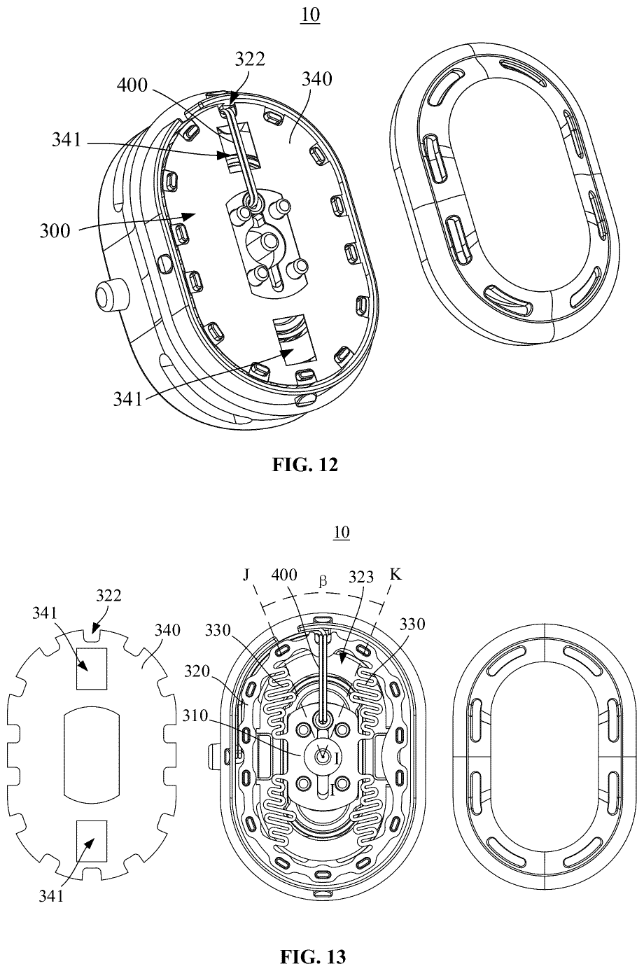

In some embodiments, as shown in FIG. 12 and FIG. 13, the vibration transmission plate 300 may further include a backing film 340 attached to the inner ring portion 310, the outer ring portion 320, and the plurality of connecting rods 330. The backing film 340 may be used for waterproofing and dustproofing. In other embodiments, the backing film 340 may be configured as an air conduction diaphragm, which can cooperate with the bone conduction sounding assembly 10 to generate a low-frequency air conduction sound.

Configuring the backing film 340 to be attached to the inner ring portion 310, the outer ring portion 320, and the plurality of connecting rods 330 allows the backing film 340 to further restrict deformation of the connecting rods 330, thereby reducing the air conduction noise generated by the connecting rods 330.

In some embodiments, the backing film 340 may be made of materials such as a gauze, a cotton sheet, or a plastic sheet.

In some embodiments, the backing film 340 may be disposed on a side of the connecting rod 330 away from the transducer device 200 along the axial direction A of the transducer device 200.

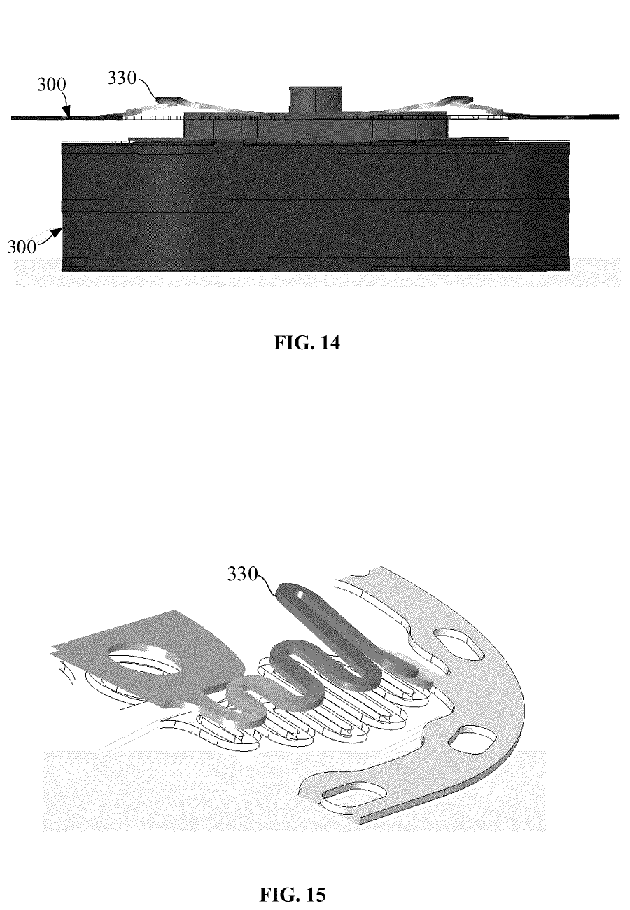

During the deformation of the rod body 331, the N+2th mode may exist. In the N+2th mode, the rod body 331 may deform along the axial direction B of the transducer device 200. For example, the N+2th mode of the rod body 331 may present a mode shown in FIG. 14 and FIG. 15 or a mode similar to that shown in FIG. 14 and FIG. 15. As another example, the entire rod body 331 may move along the axial direction B of the transducer device 200 in a direction away from the transducer device 200.

When the rod body 331 is about to present the N+2th mode, the backing film 340 located on the side of the connecting rod 330 away from the transducer device 200 may restrict and block a movement of the rod body 331, thereby reducing the air conduction noise generated by the rod body 331 and improving the sound quality of the earphone 1.

In some embodiments, counts of the curved rod sections 3316 on two sides of the first reference line ED respectively may be between 3 and 8. For example, the counts of curved rod sections 3316 on the two sides of the first reference line ED may be values such as 5, 6, 7, or 8.

If the counts of curved rod sections 3316 on the two sides of the first reference line ED are less than 3, the rod body 331 may present a large-amplitude swing in the N+2th mode, which is not conducive for the backing film 340 in suppressing swing of the rod body 331. If the counts of curved rod sections 3316 on the two sides of the first reference line ED are greater than 8, a lateral stiffness of the rod body 331 may decrease, so as to relatively reduce the reliability of the rod body 331. Therefore, setting the counts of curved rod sections 3316 on the two sides of the first reference line ED are respectively to be between 3 and 8 may reduce an occurrence of the large-amplitude swing of the rod body 331, and the backing film 340 may also better suppress swing of the rod body 331, thereby reducing the air conduction noise generated by the rod body 331, so as to improve the sound quality of the earphone 1. Simultaneously, the lateral stiffness of the rod body 331 may be increased, and the reliability of the vibration transmission plate 300 may be improved.

For example, in some embodiments, the counts of curved rod sections 3316 on the two sides of the first reference line ED may be 5. In other words, the rod body 331 includes a total of 10 curved rod sections 3316. With such configuration, the rod body 331 may have a relatively strong lateral stiffness, so as to enable the rod body 331 to be less prone to fracture during the deformation with the transducer device 200, thereby improving the reliability and structural stability of the vibration transmission plate 300. Simultaneously, the rod body 331 does not present the large-amplitude swing. Accordingly, a phenomenon where the backing film 340 is punctured and damaged by the rod body 331 may be reduced, and the backing film 340 may also better suppress swing of the rod body 331, so as to reduce the air conduction noise generated by the rod body 331.

In some embodiments, as shown in FIG. 6, FIG. 12, and FIG. 13, the inner ring portion 310 and/or the outer ring portion 320 are provided with a wiring hole 322. The vibration transmission plate 300 further includes a third reference line IJ and a fourth reference line IK. The third reference line IJ and the fourth reference line IK pass through a center of the inner ring portion 310 and respectively intersect the outer ring portion 320, thereby defining a wiring area. The wiring hole 322 is located in the wiring area 323, the connecting rod 330 is located outside the wiring area 323, and an angle between the third reference line IJ and the fourth reference line IK for defining the wiring area 323 is between 30° and 50°.

For example, the angle between the third reference line IJ and the fourth reference line IK for defining the wiring area 323 may be values such as 30°, 32°, 35°, 38°, 40°, 43°, 45°, 48°, or 50°.

As shown in FIG. 12 and FIG. 13, the earphone 1 may include a wire 400. The wire 400 extends through the wiring hole 322 and the center of the inner ring portion 310 into an interior of the transducer device 200 and is electrically connected to the voice coil 210. The wiring hole 322 is disposed in the wiring area 323. The connecting rod 330 is disposed outside the wiring area 323.

Merely by way of example, the center of the inner ring portion 310 may be shown by a point I in FIG. 6 and FIG. 13. The third reference line and the fourth reference line may be shown by a line IJ and a line IK in FIG. 6 and FIG. 13. The angle between the third reference line IJ and the fourth reference line IK for defining the wiring area 323 may be shown by an angle β in FIG. 6 and FIG. 13.

If the angle between the third reference line IJ and the fourth reference line IK for defining the wiring area 323 is greater than 50°, the wiring area 323 may have an excessively large area, and a spacing between two connecting rods 330 on two sides of the wiring area 323 may be too large, which may affect a vibration damping effect of the connecting rod 330. If the angle between the third reference line IJ and the fourth reference line IK for defining the wiring area 323 is less than 30°, the wiring area 323 may have an excessively small area, and a spacing between connecting rods 330 on the two sides of the wiring area 323 may be too small, which may cause the connecting rod 330 to easily contact the wire 400 during deformation, thereby resulting in a relatively large noise and an easy cut of the wire 400.

Therefore, setting the angle between the third reference line IJ and the fourth reference line IK for defining the wiring area 323 to be between 30° and 50° may increase a transmission effect of the connecting rod 330, such as vibration damping, so as to reduce a housing vibration unrelated to sound generation, reduce a tingling sensation felt by a human face, and enable the connecting rod 330 to be less likely to contact the wire 400. Further, a noise from collision between the connecting rod 330 and the wire 400 can be reduced, a risk of the wire 400 being cut by the connecting rod 330 can be reduced, a bending degree of the wire 400 can be reduced, thereby facilitating an installation of the wire 400.

In some embodiments, as shown in FIG. 12 and FIG. 13, the backing film 340 may include a through hole 410 at a position corresponding to the wiring area 323. The wire 400 may be routed from above the through hole 410 to the wiring hole 322. Providing the through hole 410 in the backing film 340 may be more conducive to a clearance of the wire 400 and can reduce a situation where an installation margin of the wire 400 whips the backing film 340, thereby reducing an unnecessary noise.

In some embodiments, a shape of the through hole 410 may be a rectangle. As shown in FIG. 12 and FIG. 13, the backing film 340 may include two through holes 410 arranged along a major axis direction of the vibration transmission plate 300. The two through holes 410 are spaced apart on two sides of the center of the inner ring portion 310. With such configuration, the backing film 340 may be axisymmetrically arranged along the major axis of the vibration transmission plate 300, thereby improving the structural stability and balance of the backing film 340, so as to reduce a tearing damage of the backing film 340 when the backing film 340 restricts the deformation of the connecting rod 330.

In summary, the vibration transmission plate 300 of the present disclosure includes the inner ring portion 310, the outer ring portion 320, and the plurality of connecting rods 330 connected between the inner ring portion 310 and the outer ring portion 320. One end of the connecting rod 330 is connected to the inner ring portion 310 via the first connection portion. The other end of the rod body is connected to the outer ring portion 320 via the second connection portion 333. A connection point between the connecting rod 330 and the inner ring portion 310 and a connection point between the connecting rod 330 and the outer ring portion 320 define the first reference line ED. The rod body 331 of the connecting rod 330 is divided by the first reference line ED into the first portion 3311 and the second portion 3312. The area ratio of the first portion 3311 to the second portion 3312 is between 0.8 and 1.2. With such configuration, the areas of the first portion 3311 and the second portion 3312 may be consistent or tend to be consistent. When the first portion 3311 and the second portion 3312 with similar areas deform in opposite directions in the Nth mode of the vibration transmission plate 300, the air conduction noises generated by the first portion 3311 and the second portion 3312 may cancel each other out, thereby achieving an effect of reducing air conduction noise of the rod body 331, so as to improve the sound output effect of the bone conduction sounding assembly 10, and enhance the sound quality of the earphone 1.

The foregoing embodiments are merely illustrative and do not limit the patent scope of the present disclosure. Any equivalent structure or equivalent process transformation made based on the content of the specification and drawings of the present disclosure, or direct or indirect application in other related technical fields, is similarly included within the patent protection scope of the present disclosure.

1. A vibration transmission plate, comprising:
an inner ring portion;
an outer ring portion; and
a plurality of connecting rods connected between the inner ring portion and the outer ring portion, the connecting rod comprising a rod body, a first connection portion, and a second connection portion, wherein
one end of the rod body is connected to the inner ring portion via the first connection portion;
the other end of the rod body is connected to the outer ring portion via the second connection portion;
when viewed along an axial direction of the vibration transmission plate, the vibration transmission plate includes a major axis and a minor axis intersecting each other, wherein a size of the vibration transmission plate along the major axis is greater than a size along the minor axis; and
the vibration transmission plate further includes a first reference point located at a connection between the first connection portion and the rod body, a second reference point located at a connection between the second connection portion and the rod body, and a first reference line defined by the first reference point and the second reference point, wherein the rod body is divided by the first reference line into a first portion and a second portion located on two sides of the first reference line, and an area ratio of the first portion to the second portion is between 0.8 and 1.2.

2. The vibration transmission plate of claim 1, wherein the area ratio of the first portion to the second portion is between 0.9 and 1.1.

3. The vibration transmission plate of claim 1, wherein
the rod body includes a first main edge and a second main edge arranged opposite to each other;
the first connection portion includes a first transition edge connecting the first main edge and an outer ring edge of the inner ring portion, the second connection portion includes a second transition edge connecting the second main edge and an inner ring edge of the outer ring portion, and the first transition edge and the second transition edge are respectively configured as a concave arc; and
the first reference point is a connection point between the first transition edge and the first main edge, the second reference point is a connection point between the second transition edge and the second main edge, and remaining intersection points of the first reference line with the first main edge and the second main edge are located between the first reference point and the second reference point.

4. The vibration transmission plate of claim 1, wherein
the rod body comprises a plurality of straight rod sections arranged side by side and spaced apart from each other and a plurality of curved rod sections sequentially connecting the plurality of straight rod sections.

5. The vibration transmission plate of claim 4, wherein the rod body includes a first main edge and a second main edge arranged opposite to each other, wherein
the first main edge comprises a first straight edge located on the straight rod section and a first curved edge located on the curved rod section; and
the second main edge comprises a second straight edge located on the straight rod section and a second curved edge located on the curved rod section, wherein
the first straight edge and the second straight edge located a same straight rod section are parallel to each other;
the first straight edge is tangent to the first curved edge connected thereto;
the second straight edge is tangent to the second curved edge connected thereto; and
the first curved edge and the second curved edge located a same curved rod section are configured in a concentric arc shape.

6. The vibration transmission plate of claim 4, wherein
the vibration transmission plate further include s a second reference line passing through a midpoint of a line connecting the first reference point and the second reference point and intersecting the first reference line, wherein the second reference line is located between two adjacent straight rod sections of the plurality of straight rod sections and is parallel to the two adjacent straight rod sections; and
the rod body is divided by the second reference line into a third portion and a fourth portion located on two sides of the second reference line, wherein an area ratio of the third portion to the fourth portion is between 0.8 and 1.2.

7. The vibration transmission plate of claim 4, wherein counts of the curved rod sections on two sides of the first reference line are the same.

8. The vibration transmission plate of claim 6, wherein an intersection angle between the second reference line and the first reference line is between 80° and 100°.

9. The vibration transmission plate of claim 4, further comprising a backing film attached to the inner ring portion, the outer ring portion, and the plurality of connecting rods.

10. The vibration transmission plate of claim 4, wherein counts of the curved rod sections on two sides of the first reference line are respectively between 3 and 8.

11. The vibration transmission plate of claim 6, wherein lengths of the plurality of straight rod sections increase along a direction approaching the second reference line.

12. The vibration transmission plate of claim 1, wherein
the inner ring portion and/or the outer ring portion are provided with a wiring hole;
the vibration transmission plate further includes a third reference line and a fourth reference line, the third reference line and the fourth reference line passing through a center of the inner ring portion and respectively intersecting the outer ring portion, thereby defining a wiring area; and
the wiring hole is located in the wiring area, and the connecting rod is located outside the wiring area.

13. A bone conduction sounding assembly, comprising:
a housing;
a transducer device; and
the vibration transmission plate according to claim 1, wherein the vibration transmission plate is configured to connect the transducer device and the housing, and suspendably mount the transducer device to the housing.

14. An earphone, comprising the bone conduction sounding assembly of claim 13.

15. The vibration transmission plate of claim 1, wherein the first connection portion is arranged in a gradually widening manner along a direction approaching the inner ring portion.

16. The vibration transmission plate of claim 1, wherein the second connection portion is arranged in a gradually widening manner along a direction approaching the outer ring portion.

17. The vibration transmission plate of claim 6, wherein the area ratio of the third portion to the fourth portion is between 0.9 and 1.1.

18. The vibration transmission plate of claim 9, wherein the backing film is made of a gauze, a cotton sheet, or a plastic sheet.

19. The vibration transmission plate of claim 9, wherein the backing film is configured as an air conduction diaphragm.

20. The vibration transmission plate of claim 19, wherein an angle between the third reference line and the fourth reference line for defining the wiring area is between 30° and 50°.
